(19) United States
(12) Patent Application Publication
(10) Pub. No.: US 2013/0266813 A1
(43) Pub. Date: Oct. 10, 2013

(54) ENHANCED DURABILITY OF STRUCTURAL ADHESIVES

(71) Applicant: Douglas L. Faulkner, Oak Park, MI (US)

(72) Inventor: Douglas L. Faulkner, Oak Park, MI (US)

(73) Assignee: GM GLOBAL TECHNOLOGY OPERATIONS LLC, Detroit, MI (US)

(21) Appl. No.: 13/438,985

(22) Filed: Apr. 4, 2012

(51) Int. Cl. C09J 11/06; B32B 37/12; B32B 15/04

(52) U.S. Cl. CPC C09J 11/06; B32B 15/043; B32B 37/1284
USPC 428/418; 428/457; 428/467; 428/447; 428/425.8; 428/463; 156/60; 156/330; 156/332; 156/331.7; 106/287.22; 106/287.13

(57) ABSTRACT

An exemplary embodiment discloses a structural adhesive including a structural adhesive; and, a hydrophobic material additive comprising a material selected from the group consisting of oil and carbon black.

### TECHNICAL FIELD

The field to which the disclosure generally relates includes structural adhesives, and more specifically to structural adhesives used to bond structural materials including metals, such as steel.

### BACKGROUND

A class of adhesives referred to as “structural adhesives” or “engineering adhesives” includes epoxies, polyurethane, acrylic, cyanoacrylate, and other chemistries. Structural adhesives are used in the construction of aircraft, automobiles, bicycles, boats, golf clubs, skis, snow boards, and the like, where high strength bonds are required. There are a wide range of epoxy adhesives that may be useful for a wide range of structural applications and have good heat and chemical resistance.

One particular application is in the formation of bonds of structural metals, including steel, such as cold rolled steel, to another structural metal. One shortcoming in structural adhesive bonds including bonds of structural metals is the fact that the presence of water, either internal or external to the adhesive bond, may be a prime contributor to the strength degradation of structural adhesive bonds.

### SUMMARY OF EXEMPLARY EMBODIMENTS OF THE INVENTION

In an exemplary embodiment, a structural adhesive is provided including a structural adhesive; and, a hydrophobic material additive.

In another exemplary embodiment, a method of bonding structural materials is provided including providing a first member including a metal; applying a structural adhesive to said first member, said structural adhesive including a hydrophobic material additive; joining a second member including a metal to said first member; and curing said structural adhesive and said hydrophobic material additive to form a bond between said first and second members.

In another exemplary embodiment, a structural adhesive bond is provided including a first member including a metal; a second member including a metal

wherein said first and second members are joined together through a structural adhesive, said structural adhesive including a hydrophobic material additive.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIGS. 1A-1C show structural material members being bonded with a structural adhesive according to an exemplary embodiment.

FIGS. 2A-2B show the lap shear strength of structural adhesive bonds formed according to exemplary embodiments upon exposure to water over an extended period of time.

FIG. 3 shows a process flow according to exemplary embodiments.

### DETAILED DESCRIPTION OF EXEMPLARY EMBODIMENTS

The following description of the embodiment(s) is merely exemplary (illustrative) in nature and is in no way intended to limit the invention, its application, or uses.

In an exemplary embodiment, an adhesive bond is provided with improved hydrophobicity by the addition of small amounts of hydrophobic material to a structural adhesive. In some embodiments, the hydrophobic material may be carbon-carbon bonded hydrophobic material such as a hydrophobic oil and carbon black. In some embodiments, the hydrophobic material may be added in an amount ranging from about 0.1 wt % to about 10 wt % of the structural adhesive weight, in other embodiments, from about 0.1 wt % to about 5 wt %.

In some embodiments, the structural adhesive may include one or more of epoxy, polyurethane, acrylic, and cyanoacrylate. In some embodiments, the structural adhesive may include an epoxy that requires mixture with an appropriate catalyst, also referred to as a ‘hardener’, which may result in an exothermic reaction and a curing period to form a hardened matrix, thereby gluing contacted materials together. It will be appreciated that a curing period may include different amounts of time, depending on the formulation and the curing temperature.

In some embodiments, the hydrophobic material may be added to the adhesive prior to curing or hardening the adhesive. For example, hydrophobic material may be added to the adhesive either prior to, during, or following the addition of a hardener, if required, but in one embodiment, prior to joining of members to be adhered (glued) together. For example, in some embodiments at least two members may be joined by first adding an adhesive to a bonding area including one or more members, followed by contacting (joining) one or more additional members to the adhesive containing bonding area, followed by curing (hardening) of the adhesive.

In one embodiment, the hydrophobic material may be an oil having substantially no water content, for example an outgassed oil, such as a vacuum pump (VP) oil. In one embodiment, the vacuum pump oil may be suitable for use in a rotary vane vacuum pump or a diffusion pump. In some embodiments, the vacuum pump oils may be previously treated by heating in vacuum to outgas the oil, thereby removing volatile components including water. In other embodiments, oils with a low water content may be used, e.g. less than about 0.5 wt %, more preferably less than about 0.1 wt %, even more preferably less than about 0.05 wt %.

In one embodiment, the oil may be a hydrophobic siloxane polymer based oil which may include alternating and repeating silicon-oxygen bonds (e.g., Si—O—Si—O etc.). In other embodiments, the oil may be a carbon based oil with repeating carbon-carbon bonds.

In another embodiment, the hydrophobic material may be a hydrophobic amorphous carbon material, such as hydrophobic carbon black. In some embodiments, the hydrophobic carbon black may be a furnace produced material. In other embodiments the carbon black may be formed by a process to form an acid oxidized surface e.g., formed by spraying acid into the furnace during the formation process as is known in the art.

In one embodiment, the carbon black may have a primary particle size from about 10 nm to about 500 nm, where the primary particle size may be measured by known transmission electron microscopic (TEM) and/or gas adsorption processes. It will be appreciated that the carbon black may include isolated as well as agglomerated primary particles.

In one embodiment, the carbon black material may a carbon black that is suitable for use as a pigment in printing inks and other coatings, such as Elftex 8™, commercially available from Cabot Corporation.

In some embodiments, at least one of the members to be bonded may be a structural steel alloy. In some embodiments the structural steel may be a cold rolled steel alloy. In one embodiment, an exemplary type of cold rolled steel may be 1010 alloy. In some embodiments, the cold rolled steel alloy includes mostly iron, with a carbon content of between 0.2% and 2.14% by weight (C: 110-10Fe), depending on grade. Various amounts of other alloying elements may be included such as manganese, chromium, vanadium, and tungsten.

In other embodiments at least one of the members to be bonded through the hydrophobic material containing structural adhesive may be a structural metal alloy or metal alloy composite, for example as a part of a conventional internal combustion (IC) engine, or a structural part of an IC, electric or hybrid automobile.

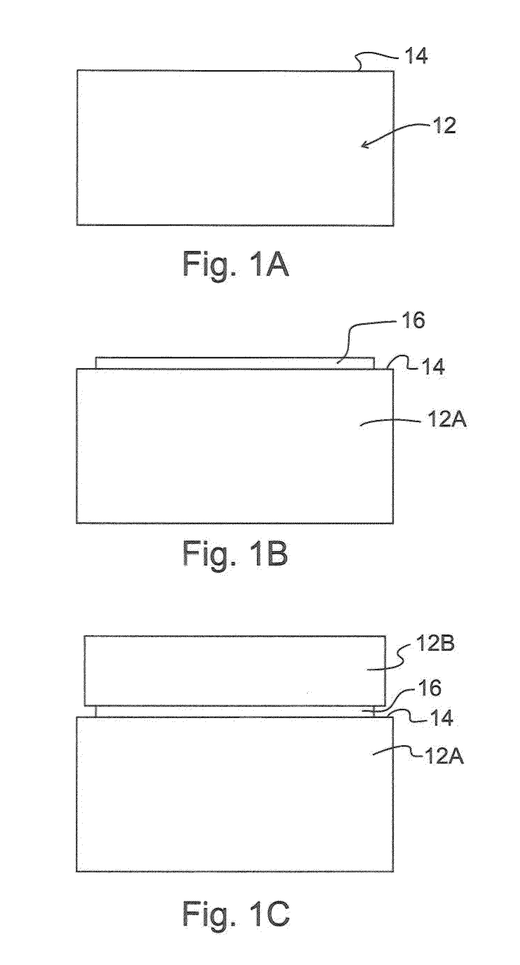

For example, in an exemplary process, referring to FIG. 1A, a first structural material member 12A is provided with a cleaned and dried surface 14. In one embodiment, the surface may be cleaned by a hydrophobic liquid material containing substantially no water (e.g., less than about 0.1 wt %). Referring to FIG. 1B, a structural adhesive 16 according to embodiments is applied to surface 14 of the structural material member 12A In one embodiment, hydrophobic material may be added to the adhesive 16 (e.g., mixed), prior to contacting the adhesive to the surface 14. In other embodiments the hydrophobic material may be added to the adhesive 16, during and/or following contacting the adhesive to the surface 14. For example, in one embodiment, the hydrophobic material, such as hydrophobic carbon black and/or hydrophobic oil may be mixed with the adhesive prior to contacting the adhesive 16 to the surface 14. In other embodiments, the hydrophobic material may be applied to the adhesive e.g., applied to the surface of the adhesive and/or mixed with the adhesive following contacting the adhesive to the surface 14.

In other embodiments, the hydrophobic material may be mixed with a hydrophobic solvent and may be sprayed or brushed onto the adhesive material 16 prior to or following application of the adhesive material 16 to the surface 14 of structural material member 12A. In the case the hydrophobic material 16 is applied to the surface of the adhesive 16, it will be appreciated that the hydrophobic material may be only present in a surface region of the adhesive material.

Referring to FIG. 1C, following application of the adhesive 16 including hydrophobic material to the structural material member 12A, another structural member 12B, which may be a different type of structural material or the same type of structural material as structural material member 12A, may then be joined to the member 12A with the adhesive 16 (including hydrophobic material) acting as a contact interface between the members 12A and 12B. The adhesive and hydrophobic material additive may then be cured (hardened) in order to form a structural adhesive bond gluing the two members 12A and 12B together.

For example, in some embodiments, the structural adhesive 16 may be an epoxy requiring the addition of a hardener to act as a catalyst to produce an exothermic chemical reaction to initiate the curing process. In some embodiments, the hardener may be added prior to, during, or following addition of the hydrophobic materials to the adhesive, but preferably prior to joining the members for subsequent curing and bonding.

In some embodiments, heat may be applied to the adhesive prior to or following joining of members to be bonded in contact with the adhesive and hydrophobic material. In some embodiments, pressure (e.g., a load) may be applied to one or more of the members and adhesive (bond) following joining of members to be bonded (in contact with the adhesive including hydrophobic material).

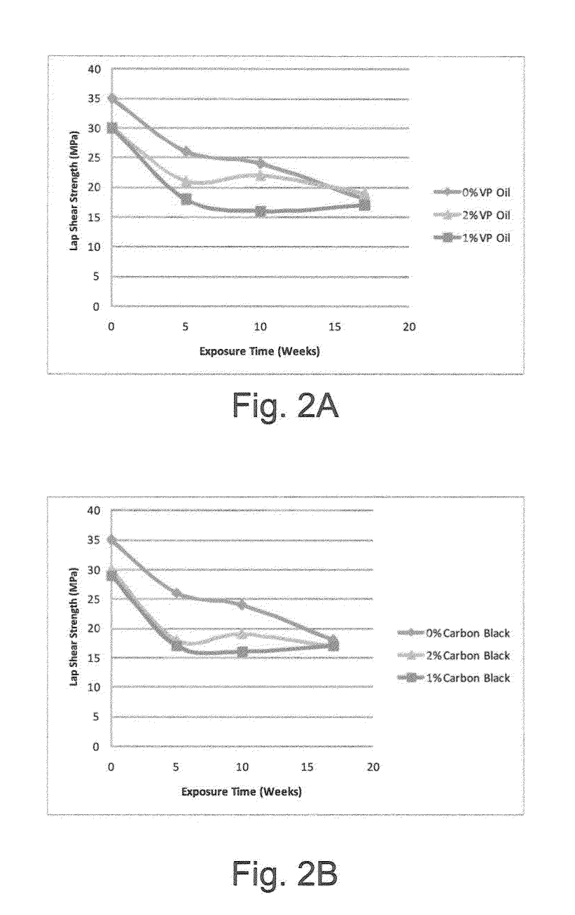

It has been unexpectedly found that addition of hydrophobic material to a structural adhesive, according to embodiments, increases the resistance of a structural bond to water induced weakening or degradation. For example, referring to FIGS. 2A and 2B are shown test results of lap shear strength following subjecting exemplary bonded joints of cold rolled steel (alloy 1010) bonded with an exemplary epoxy (Betamate™ 4601) and including a control sample and added hydrophobic material (oil-FIG. 2A; carbon black-FIG. 2B). The lap shear strength (x axis) test results are a function of soaking the bonded joint with water at about 80° C. for selected periods of time (Y axis). In FIG. 2A, lap shear strength results are shown for 0 wt %, 1 wt %, and 2 wt % oil (VP) additive amounts to the exemplary epoxy.

It may be seen that the lap shear strength starts to level off at about 5 to 10 weeks with the sample adhesive bonds including 1 wt % and 2 wt % hydrophobic oil additions. In contrast, it may be seen that the control sample (0 wt % oil) continues to decrease in lap shear strength without leveling off or plateauing. It may be seen that at about 17 weeks the lap shear strength of the control sample (0 wt % oil) is similar to the lap shear strength of the sample having 1 wt % oil, while the sample containing 2 wt % oil exhibits about a 12% increase (improvement) in lap shear strength over the control sample(0 wt % oil). Therefore, despite an initial decrease of about 12% in lap shear strength with respect to oil containing samples, at longer time periods, the lap shear strength of sample adhesive bonds having the oil additive is improved with respect to an adhesive bond without the oil additive.

Similarly, referring to FIG. 2B, where a control sample (0 wt % carbon black) is compared to samples with the addition of 2 wt % and 4 wt % carbon black, it may be seen that the samples with carbon black level off or plateau while the control sample continues to decrease in lap shear strength. Thus, continuing the trend in decreasing lap shear strength of the control sample, the sample adhesive bonds with added carbon black may be expected to exhibit superior lap shear strength compared to adhesive bonds without carbon black at longer time periods.

In addition, it has been found that the lap shear strength of the exemplary structural adhesive bonds with exemplary hydrophobic additives far exceeds required performance specifications for metal bonding at elevated temperatures including in vehicle applications.

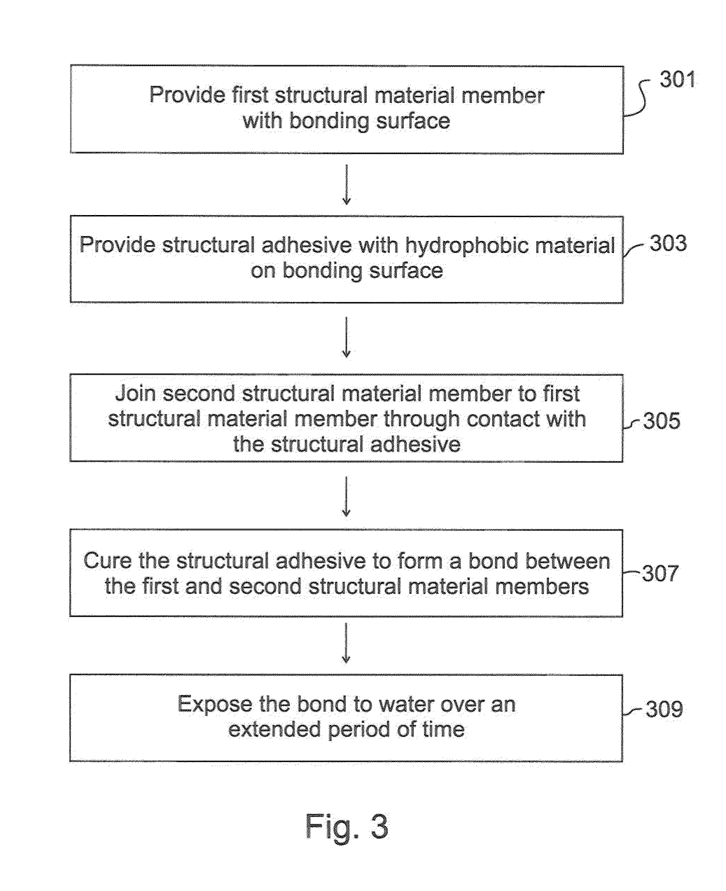

Referring to FIG. 3, is shown a process flow diagram for performing a bonding process with the structural adhesive with hydrophobic material additives according to exemplary embodiments. In step 301, a first structural material member having a bonding surface is provided. In step 303, a structural adhesive with hydrophobic material additive is provided on a surface of the first structural material member. In step 305, a second structural material member is joined to the first structural material member by contacting a bonding surface of the second structural material member to the structural adhesive with hydrophobic material additive. In step 307, the structural adhesive with hydrophobic material additive is cured to form the first and second structural material members bonded together. In step 309, the cured structural bond may be exposed to water over an extended period of time.

Among the various advantages of the embodiments include a low cost and readily applicable method to improve the strength of adhesive bonds of structural metal containing material, such as cold rolled steel when exposed to water over an extended period of time. Such benefits are achieved while maintaining other properties of the adhesive bond, such as strength at elevated temperatures, an advantage that may be particularly advantageous in automotive applications including electric and hybrid vehicles.

The above description of embodiments of the invention is merely exemplary in nature and, thus, variations thereof are not to be regarded as a departure from the spirit and scope of the invention.

What is claimed is:

1. A structural adhesive comprising:
a structural adhesive; and,
a hydrophobic material additive comprising an oil.

2. The structural adhesive of claim 1, wherein said structural adhesive is selected from the group consisting of epoxy, polyurethane, acrylic, and cyanoacrylate.

3. The structural adhesive of claim 1, wherein the structural adhesive comprises an epoxy.

4. The structural adhesive of claim 1, wherein said hydrophobic material further comprises carbon black.

5. The structural adhesive of claim 4, wherein said carbon black comprises a material suitable for use as a pigment.

6. (canceled)

7. The structural adhesive of claim 1, wherein said oil comprises a vacuum pump oil.

8. The structural adhesive of claim 1, wherein said oil comprises a carbon based oil.

9. The structural adhesive of claim 1, wherein said oil comprises a siloxane based oil.

10. The structural adhesive of claim 1, wherein said hydrophobic material is present is said structural adhesive in an amount of about 0.1 wt % to about 10 wt %.

11. A method of bonding structural materials comprising:
providing a first member comprising a metal;
applying a structural adhesive to said first member, said structural adhesive comprising a hydrophobic material additive wherein the hydrophobic material additive comprises an oil;
joining a second member comprising a metal to said first member; and
curing said structural adhesive and said hydrophobic material additive to form a bond between said first and second members.

12. The method of claim 11, wherein said hydrophobic material additive is mixed with the structural adhesive including at least one of prior to or following application of the structural adhesive to the first member.

13. The method of claim 11, wherein said hydrophobic material additive is applied to a surface of the structural adhesive following application of the structural adhesive to the first member.

14. The method of claim 11, wherein heat is applied to the structural adhesive and hydrophobic material additive during said step of curing.

15. The method of claim 11, wherein said structural adhesive is selected from the group consisting of epoxy, polyurethane, acrylic, and cyanoacrylate.

16. The method of claim 11, wherein the structural adhesive comprises an epoxy.

17. The method of claim 11, wherein the hydrophobic material additive further comprises carbon black.

18. The method of claim 17, wherein said carbon black comprises a material suitable for use as a pigment.

19. (canceled)

20. The method of claim 11, wherein said oil comprises a vacuum pump oil.

21. The method of claim 11, wherein said oil comprises a carbon based oil.

22. The method of claim 11, wherein said oil comprises a siloxane based oil.

23. The method of claim 11, wherein said hydrophobic material is present is said structural adhesive in an amount of about 0.1 wt % to about 10 wt %.

24. The method of claim 11, wherein at least one of said first and second metal members comprises steel.

25. The method of claim 11, wherein at least one of said first and second metal members comprises cold rolled steel.

26. The method of claim 11, wherein at least one of said first and second metal members comprises a vehicle structural part.

27. A structural adhesive bond comprising:
a first member comprising a metal;
a second member comprising a metal;
wherein said first and second members are joined together through a structural adhesive, said structural adhesive comprising a hydrophobic material additive wherein the hydrophobic material additive comprises an oil.

28. The structural adhesive bond of claim 27, wherein at least one of said first and second metal members comprises steel.

29. The structural adhesive bond of claim 27, wherein at least one of said first and second metal members comprises cold rolled steel.

30. The structural adhesive bond of claim 27, wherein at least one of said first and second metal members comprises a vehicle structural part.

31. The structural adhesive bond of claim 27, wherein said hydrophobic material additive further comprises carbon black.

32. The structural adhesive bond of claim 31, wherein said carbon black comprises a material suitable for use as a pigment.

33. (canceled)

34. The structural adhesive bond of claim 27, wherein said oil comprises a vacuum pump oil.

35. The structural adhesive bond of claim 27, wherein said oil comprises a carbon based oil.

36. The structural adhesive bond of claim 27, wherein said oil comprises a siloxane based oil.

37. The structural adhesive bond of claim 27, wherein said structural adhesive is selected from the group consisting of epoxy, polyurethane, acrylic, and cyanoacrylate.

38. The structural adhesive bond of claim 27, wherein the structural adhesive comprises an epoxy.

39. The structural adhesive bond of claim 27, wherein said hydrophobic material is present is said structural adhesive in an amount of about 0.1 wt % to about 10 wt %.

40. A structural adhesive comprising:
a structural adhesive; and,
a hydrophobic material additive wherein the hydrophobic material additive comprises an oil present in the structural adhesive before application to a structural material member.

41. A method of bonding structural materials comprising:
providing a first member comprising a metal;
applying a structural adhesive to said first member, said structural adhesive comprising a hydrophobic material additive wherein the hydrophobic material additive comprises an oil present in the structural adhesive before application to a first member;
joining a second member comprising a metal to said first member; and
curing said structural adhesive and said hydrophobic material additive to form a bond between said first and second members.

42. A structural adhesive bond comprising:
a first member comprising a metal;
a second member comprising a metal;
wherein said first and second members are joined together through a structural adhesive, said structural adhesive comprising a hydrophobic material additive wherein the hydrophobic material additive comprises an oil present in the structural adhesive before application to at least one of a first or second member.

43. A structural adhesive comprising:
a structural adhesive; and,
a hydrophobic material additive wherein the hydrophobic material additive comprises an oil present in the structural adhesive after application to a structural material member.

44. A method of bonding structural materials comprising:
providing a first member comprising a metal;
applying a structural adhesive to said first member,
applying a hydrophobic material comprising oil to the structural adhesive,
joining a second member comprising a metal to said first member; and
curing said structural adhesive and said hydrophobic material additive to form a bond between said first and second members.

45. A structural adhesive bond comprising:
a first member comprising a metal;
a second member comprising a metal;
wherein said first and second members are joined together through a structural adhesive, said structural adhesive comprising a hydrophobic material additive wherein the hydrophobic material additive comprises an oil present in the structural adhesive after application to at least one of a first or second member.

46. The structural adhesive of claim 1, wherein said oil has a water content of less than about 0.5 wt %.

47. The method of claim 11, wherein said oil has a water content of less than about 0.5 wt %.

48. The structural adhesive bond of claim 27, wherein said oil has a water content of less than about 0.5 wt %.
